(19) United States
(12) Patent Application Publication
(10) Pub. No.: US 2003/0135427 A1
(43) Pub. Date: Jul. 17, 2003

(54) Vehicle sales method, server device, and area information displaying and charging system for a car

(76) Inventor: Makoto Murakami, Tokyo (JP)

Correspondence Address: LADAS & PARRY, 224 SOUTH MICHIGAN AVENUE, SUITE 1200, CHICAGO, IL, 60604, US

(21) Appl. No.: 10/331,784

(22) Filed: Dec. 26, 2002

Related U.S. Application Data
(63) Continuation of application No. PCT/JP01/01374, filed on Feb. 23, 2001.

(30) Foreign Application Priority Data
Jun. 26, 2000 (JP) 2000-191769

(51) Int. Cl. G06F 17/60

(52) U.S. Cl. 705/26

(57) ABSTRACT

A user sends order data to an order server through a network to order a car. The order server sends the received order data to an HP managing company to report the car order. The HP managing company creates ordering data according to the order data and sends it to a car maker to order production of the car. The produced car is transported to an affiliate shop, and the user receives the car and travels by the car. The car sends travel distance data every month to a charge server. The charge server calculates the charge according to the travel distance data and charges the user for the monthly charge. The user pays the charge to a charge collecting company. The charge collecting company pays a first remainder of the charge from which a first commission is subtracted to the HP managing company. The HP managing company pays a second remainder of the first remainder from which a second commission is subtracted to the car maker.

### TECHNICAL FIELD

The present invention relates to a method for selling a vehicle such as a car, a server device, and an area information displaying and charging system for a car. Particularly, the present invention relates to a method for selling a vehicle by information communication over a network, a server device, and an area information displaying and charging system for a car.

### BACKGROUND ART

Car manufacturers have been attempting to promote car sales by advertising their cars on TV commercials, magazines, posters, and the like or locating sample cars in their shops serving as showrooms.

Recently, there has been a demand for reduction of CO₂, carbon monoxide, and nitrogen oxides on a global basis in consideration of global warming and acid rain. Therefore, car manufacturers have been developing environment-friendly cars, such as fuel-efficient cars which reduce emissions of CO₂ by reducing fuel consumption, and low-emission cars (such as electric cars, hybrid cars, and the like) which reduce toxic substances in exhaust gas, thereby reducing carbon monoxide and nitrogen oxides and preventing air pollution.

However, a conventional problem exists in that costs of advertisements and maintenance of the shops are huge, resulting in increases in the sales prices of cars.

Further, even if the fuel-efficient cars and the low-emission cars are used, emissions of the toxic substances are not reduced if many people use the cars frequently. Therefore, these types of cars are not satisfactory for solving the environmental problems.

The present invention has been devised to address the above-described problems. Objects of the present invention are to provide a vehicle sales method which can reduce the sales price of a vehicle and restrain the use thereof by a purchaser of the vehicle, to provide a server device, and to add further value to the vehicle.

### DISCLOSURE OF THE INVENTION

In order to achieve the above objects, a first aspect of the present invention is a system for selling a vehicle, which has the function of transmitting data of a distance the vehicle has traveled, by information communication over a network, the system comprising: an in-vehicle device which is mounted in the vehicle and comprises measuring means for measuring the travel distance of the vehicle and transmitting means for transmitting data of the measured travel distance; and a control device comprising order receiving means for receiving a purchase order for the vehicle via the network, vehicle data receiving means for receiving the travel distance data, which has been transmitted from the in-vehicle device, at predetermined time intervals via the network after the vehicle for which the purchase order has been received is delivered to an orderer of the vehicle, calculating means for calculating a fee based on the received travel distance data, and charge signal outputting means which outputs a charge signal for charging the calculated fee to the orderer via the network.

Further, a second aspect of the present invention is a server device which performs information communication via a network, the server device comprising; order receiving means for receiving a purchase order for a vehicle; vehicle data receiving means for receiving data of a distance the vehicle has traveled at predetermined time intervals via the network after the vehicle for which the purchase order has been received is delivered to an orderer of the vehicle; calculating means for calculating a fee based on the travel distance data received by the vehicle data receiving means; and charge signal outputting means which outputs a charge signal for charging the fee calculated by the calculating means to the orderer via the network.

According to the first and second aspects of the present invention, the purchase order for the vehicle is received via information communication over the network, and the vehicle is delivered to the orderer. The vehicle may be any vehicle as long as it travels while carrying a person, such as a car, a motorcycle, a boat, a jet ski, a helicopter, a private aircraft, and the like.

The delivered vehicle is freely driven by the orderer. The travel distance data, which is transmitted by the function of the vehicle to transmit the data obtained by measuring the travel distance, is received at predetermined time intervals, and the fee determined based on the travel distance data is charged to the orderer via the network. Namely, the fee is calculated based on the travel distance at predetermined time intervals and charged to the orderer.

In this way, the purchaser (orderer) of the vehicle can obtain the vehicle by ordering the purchase of the vehicle over the network. Since the orderer only needs to pay the fee determined in accordance with the travel distance at predetermined time intervals, substantial demand for the vehicle can be obtained. A manufacturer such as a car manufacturer can obtain effects similar to those of advertisement on TV commercials and the like because the vehicles receive people's attention if a large number of the vehicles are driven in a city.

When cars are taken for example, the car manufacturers anticipate that the target unit sales of a new car are generally 5000 per month, and a car of a new type with unit sales of 10000 per month is considered to be a successful model. Effects which are equivalent to those obtained by TV commercials can be sufficiently obtained if 10000 to 15000 cars are distributed in Tokyo. The applicant confirms that, even if the car manufacturers cover the expenses for the cars and provide the cars to the purchasers (orderers) thereof for free, an amount of money calculated by adding expenses for receiving orders over the network and the like to the expenses for the cars is substantially smaller than advertisement fees for TV commercials. Further, the current Internet population is over twenty million, and the above unit sales can be obtained if 0.01% of this population can be gained as users (orderers). This is a value which can be sufficiently realized.

Therefore, the advertisement fees for TV commercials and the like can be reduced, and the sale of the vehicles over the network eliminates the need for dealers (shops). This reduces the sales price of the vehicles more than is possible with conventional art. Further, unnecessary use of the vehicles can be restrained by collecting a fee in accordance with the travel distance, which enables coping with the environmental problems.

In the first aspect of the present invention, the control device may further comprise order placement signal outputting means which outputs a signal for ordering the manufacture of the vehicle for which the purchase order has been received.

Further, the second aspect of the present invention may further comprise order placement signal outputting means which outputs a signal for ordering the manufacture of the vehicle for which the purchase order has been received by the order receiving means.

According to the present invention, the order for manufacturing the vehicle is placed after the order therefor has been received, and the vehicle which has been manufactured after the receipt of the order is delivered to the orderer. Therefore, the seller (such as a manufacturer, a selling agent, and the like) does not need to hold large stocks, and the orderer can order a desired vehicle (desired car type, design, and the like).

In the first aspect of the present invention, the control device may further comprise: determination means for determining, based on the travel distance data received by the vehicle data receiving means, whether the vehicle has been used for a predetermined period; and retrieval signal outputting means for outputting a signal for instructing retrieval of the vehicle when it has been determined by the determination means that the vehicle has not been used for the predetermined period.

Further, the second aspect of the present invention may further comprise determination means for determining, based on the travel distance data received by the vehicle data receiving means, whether the vehicle has been used for a predetermined period; and retrieval signal outputting means for outputting a signal for instructing retrieval of the vehicle when it has been determined by the determination means that the vehicle has not been used for the predetermined period.

According to the present invention, advertising effects cannot be obtained if the vehicle is not used. Therefore, the vehicle which has not been used for a predetermined period is retrieved, whereby the advertisement fee (i.e., the expense for the vehicle) can be prevented from being spent unnecessarily.

Control of the vehicle after delivery thereof to the orderer can be carried out by checking the position of the vehicle by, for example, a GPS (Global Positioning System).

Moreover, the first aspect of the present invention may be characterized in that: the in-vehicle device further comprises position measuring means for measuring the position of the vehicle by a GPS; the transmitting means transmits position data representing the measured position of the vehicle; and the control device further comprises position data receiving means for receiving the position data, and checking means for checking the position of the vehicle based on the position data. Further, the area information may be at least one of advertisement information and emergency information on the area. The area information is held in a server or the like in advance. The emergency information refers to information on an earthquake, a disaster, or the like.

Further, the second aspect of the present invention may further comprise selecting means for selecting, from information on areas, information on an area around the position of the vehicle checked by the checking means; and area information delivering means for delivering the area information selected by the selecting means to a receiving device provided at the vehicle. The area information may be at least one of advertisement information and emergency information on the area.

According to the present invention, information which is appropriate for the current position of the vehicle can be transmitted to the vehicle which has been sold by the above method. In this way, added value can be provided to the vehicle.

Moreover, the first aspect of the present invention may be characterized in that: the in-vehicle device further comprises a monitor for displaying the received area information; the transmitting means transmits a time period for which the received advertisement information has been displayed in the vehicle; the control device further comprises advertisement fee charging means for receiving, when the area information is advertisement information, the transmitted time period for every advertisement information and charging an advertisement fee determined in accordance with the time period to an advertiser via the network; and the calculating means subtracts an amount of money, which is determined based on the advertisement fee, from a fee calculated based on the travel distance data.

Further, the second aspect of the present invention may further comprise advertisement fee charging means for receiving, when the area information is advertisement information, a transmitted time period, for which the delivered advertisement information has been displayed in the vehicle, for every advertisement information and charging an advertisement fee determined in accordance with the time period to an advertiser via the network, wherein the calculating means subtracts an amount of money, which is determined based on the advertisement fee, from a fee calculated based on the travel distance data.

Furthermore, the first aspect of the present invention may be characterized in that: the in-vehicle device further comprises a status sensor for detecting status data representing at least one of engine speed, braking frequency, and steering wheel operation frequency of the vehicle; the transmitting means transmits the status data; and the control device further comprises status data receiving means for receiving the status data via the network, and signal outputting means which outputs a signal for providing the status data to a manufacturer of the vehicle as data for research and development.

Moreover, the second aspect of the present invention may further comprise: status data receiving means for receiving status data representing at least one of engine speed, braking frequency, and steering wheel operation frequency; and signal outputting means which outputs a signal for providing the status data received by the status data receiving means to a manufacturer of the vehicle as data for research and development.

According to the present invention, after the vehicle has been delivered to the orderer, the status data representing the engine speed, the braking frequency, and the steering wheel operation frequency of the vehicle when the vehicle is driven around is received and provided to the manufacturer of the vehicle such as a car manufacturer. In this way, the manufacturer of the vehicle can easily obtain data necessary for the research and development of the vehicle.

Further, although the vehicle sold by the above method may be a general-purpose vehicle such as an ordinary car, the vehicle may also be a vehicle for nursing care or amnesty.

Vehicles for nursing care or amnesty (such as vehicles for the handicapped, heavily armed vehicles, emergency vehicles, and the like) are generally expensive to purchase. However, the high cost required to purchase these vehicles can be reduced by using the above-described method. The vehicles for the handicapped are articles essential to daily life for the handicapped and are suitable for charging in accordance with the travel distance. Therefore, the vehicles for the handicapped are expected to spread dramatically by introducing the above sales method. The applicant confirms that the average annual travel distance of wheelchair-accomodatable vehicles for the handicapped is about 40000 to 60000 km.

Moreover, the vehicle may be a business vehicle. Generally, when a company purchases a business vehicle, fixed asset tax is imposed on the vehicle since the vehicle is considered an asset. However, when the business vehicle is purchased by using the above method, the travel distance is considered information, and an information service fee is charged to the company. Therefore, the company can process the expense for the vehicle as an expense for information or communication and thus seek a reduction in taxes.

Further, the first aspect of the present invention may be characterized in that: the in-vehicle device comprises a state sensor for detecting state data representing a state of the vehicle; the transmitting means transmits the detected state data; the vehicle data receiving means receives and stores the state data; and the calculating means calculates a fee based on a price of the vehicle, which is obtained by subtracting a remaining value of the vehicle after a predetermined period from the price of the vehicle at the time of selling the vehicle, and the received travel distance data.

Furthermore, the second aspect of the present invention may be characterized in that: the vehicle data receiving means receives and stores data representing a state of the vehicle; and the calculating means calculates a fee based on a price of the vehicle, which is obtained by subtracting a remaining value of the vehicle after a predetermined period from the price of the vehicle at the time of selling the vehicle, and the travel distance data received by the vehicle data receiving means.

The state of the vehicle includes engine speed, braking frequency, steering wheel operation frequency, and the like.

Further, a third aspect of the present invention is an area information delivering method which delivers information on an area via a network to a vehicle having the function of checking a current position thereof, the method comprising the steps of: receiving position data representing the current position of the vehicle; selecting, from information on areas, information on an area around the current position of the vehicle; and delivering the selected area information to a receiving device provided at the vehicle.

Furthermore, a fourth aspect of the present invention is a server device which delivers information on an area via a network to a vehicle having the function of checking a current position thereof, the server device comprising: position receiving means for receiving position data representing the current position of the vehicle; selecting means for selecting, from information on areas, information on an area around the current position of the vehicle which has been checked by the checking means; and area information delivering means for delivering the area information selected by the selecting means to a receiving device provided at the vehicle.

According to the present invention, information which is appropriate for the current position of the vehicle can be transmitted to the vehicle which has been sold by the above method. In this way, added value can be provided to the vehicle.

In the third and fourth aspects of the present invention, the area information may be at least one of advertisement information and emergency information on the area.

Moreover, the third aspect of the present invention may receive, when the area information is advertisement information, a time period for which the delivered advertisement information has been displayed in the vehicle from the vehicle for every advertisement information, and may charge an advertisement fee determined in accordance with the time period to an advertiser via the network.

Further, the fourth aspect of the present invention may further comprise advertisement fee charging means for receiving, when the area information is advertisement information, a transmitted time period, for which the delivered advertisement information has been displayed in the vehicle, for every advertisement information and charging an advertisement fee determined in accordance with the time period to an advertiser via the network.

Further, a fifth aspect of the present invention comprises: an in-vehicle device which is mounted in the vehicle and comprises transmitting means for detecting a distance the vehicle has traveled and a current position of the vehicle and transmitting distance information and positional information, and display means for displaying received area information, and a control device which comprises area information transmitting means that stores information on predetermined areas and transmits area information corresponding to the positional information, and fee processing means for processing a fee in accordance with the travel distance. According to the present invention, since the travel distance of the vehicle is transmitted from the transmitting means of the in-vehicle device, a fee determined in accordance with the travel distance can be charged by the fee processing means. Moreover, since the positional information is transmitted from the transmitting means of the in-vehicle device, appropriate area information can be transmitted from the area information transmitting means based on the positional information.

Moreover, a sixth aspect of the present invention comprises: an in-vehicle device which is mounted in the vehicle and comprises measuring means for measuring the travel distance of the vehicle and transmitting means for transmitting the measured travel distance; and a server device comprising order receiving means for receiving a purchase order for the vehicle via the network, travel distance receiving means for receiving the travel distance, which has been transmitted from the in-vehicle device, via the network after the vehicle for which the purchase order has been received is delivered to an orderer of the vehicle, calculating means for calculating a fee based on the received travel distance, and charge signal outputting means which outputs a charge signal for charging the calculated fee to the orderer via the network.

As described above, the present invention has excellent effects of reducing the sales price of the vehicle, restraining the use of the vehicle by the purchaser, and providing additional value to the user.

### BRIEF DESCRIPTION OF THE DRAWINGS

FIG. 1 is a diagram showing a structure of a network system according to a first embodiment.

FIG. 2 is a diagram schematically showing an interior of a car according to the first embodiment.

FIG. 3 is a block diagram showing a structure of the car according to the first embodiment.

FIG. 4 is a conceptual view showing a flow of all marketing services according to the first embodiment.

FIG. 5 is a flow chart of processing executed by an order server.

FIG. 6 is a flow chart of processing executed by a fee server.

FIG. 7 is an example of a homepage screen for ordering a car.

FIG. 8 is a conceptual view showing a flow of all marketing services provided when a financial institution pays a car manufacturer for a car.

FIG. 9 is a diagram showing a structure of a network system according to a second embodiment.

FIG. 10 is a block diagram showing a structure of a car according to the second embodiment.

FIG. 11 is a conceptual view showing a flow of all marketing services according to the second embodiment, including transmission of state data from the car to the car manufacturer for research and development of a car body.

FIG. 12 is a block diagram showing a structure of a car (taxi) according to another embodiment in which ride data is obtained.

FIG. 13 is a conceptual view of all marketing services according to another embodiment, including transmission of ride data from the car to a taxi company for operational control of the taxi.

FIG. 14 is a diagram showing a structure of a network system according to a third embodiment.

FIG. 15 is a block diagram showing a structure of a car according to the third embodiment.

FIG. 16A is a flow chart of processing executed by a car position control server.

FIG. 16B is a flow chart of processing executed by an advertisement transmission server.

FIG. 17 is a part of a matrix-shaped map controlled by the car position control server.

FIG. 18 is a conceptual view showing a flow of all marketing services according to another embodiment, including charging an advertisement fee to an advertiser.

### BEST MODE FOR CARRYING OUT THE INVENTION

Examples of embodiments of the present invention will be described below in detail with reference to the drawings.

### First Embodiment

Structure of Network

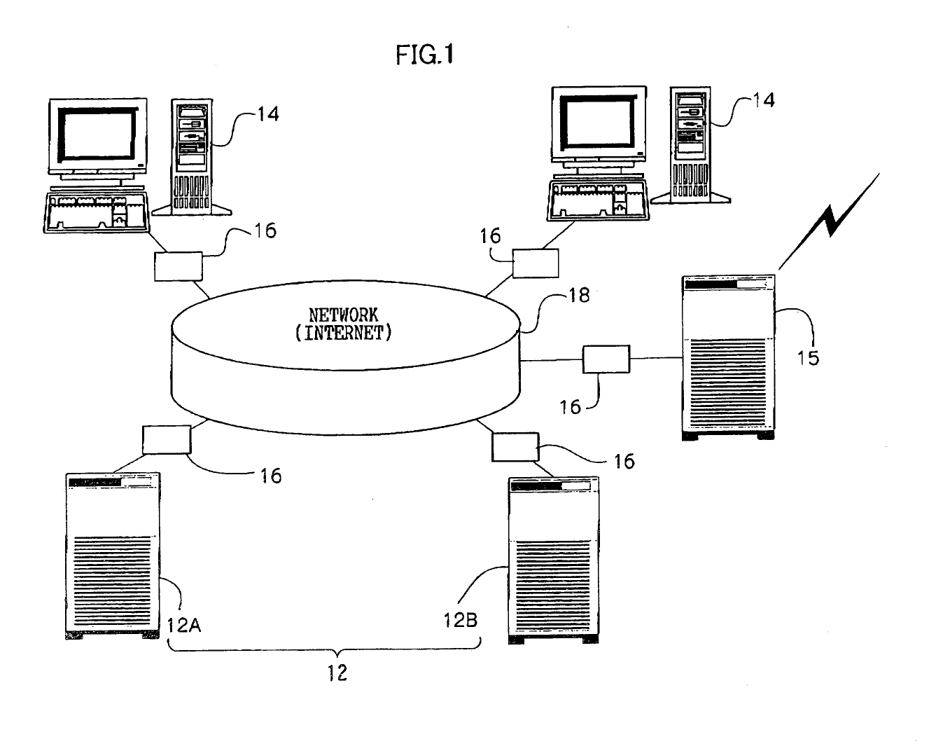

FIG. 1 shows a schematic structure of a network system to which the present invention is applied. As shown in FIG. 1, a network system 10 is formed by server devices (hereinafter referred to simply as the “servers”) 12, a plurality of computers 14, and a server device (hereinafter referred to simply as the “communication server”) 15, all of which are connected to a network 18 via connecting means 16 such as a modem, a router, a terminal adapter, and the like. The servers 12 provide marketing services for receiving an order for a car from a user, accepting the order, and collecting, from the user, a fee for the car delivered to the user. The communication server 15 communicates with a mobile phone or a communication satellite by wireless. The servers 12 and the computers 14 can communicate with each other via the network 18.

The network 18 can be any network as long as it enables two-way communication. For example, the network 18 may be the Internet, a LAN, a WAN, or a cable television network, or may use a telephone line such as in personal computer communication or satellite communication. A case in which the Internet is used as the network 18 will be described below as an example.

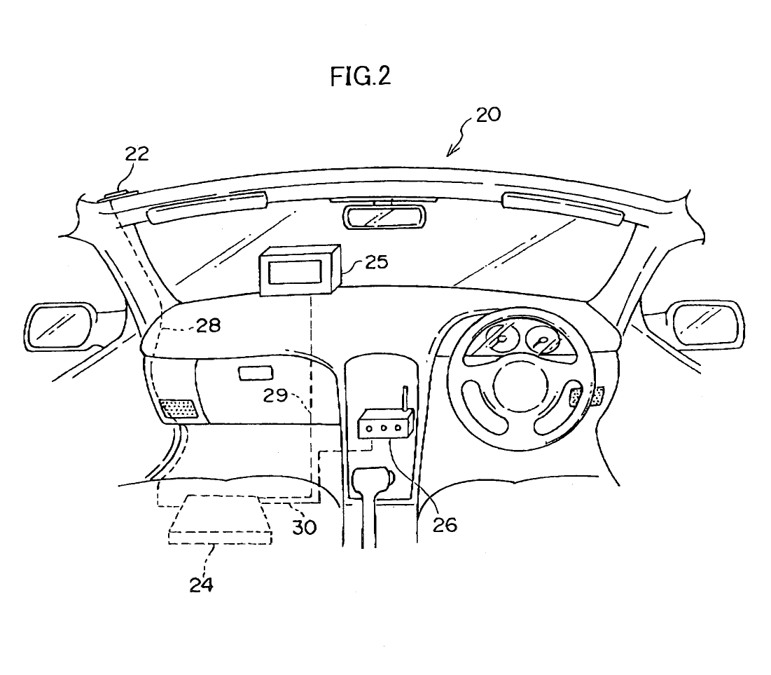

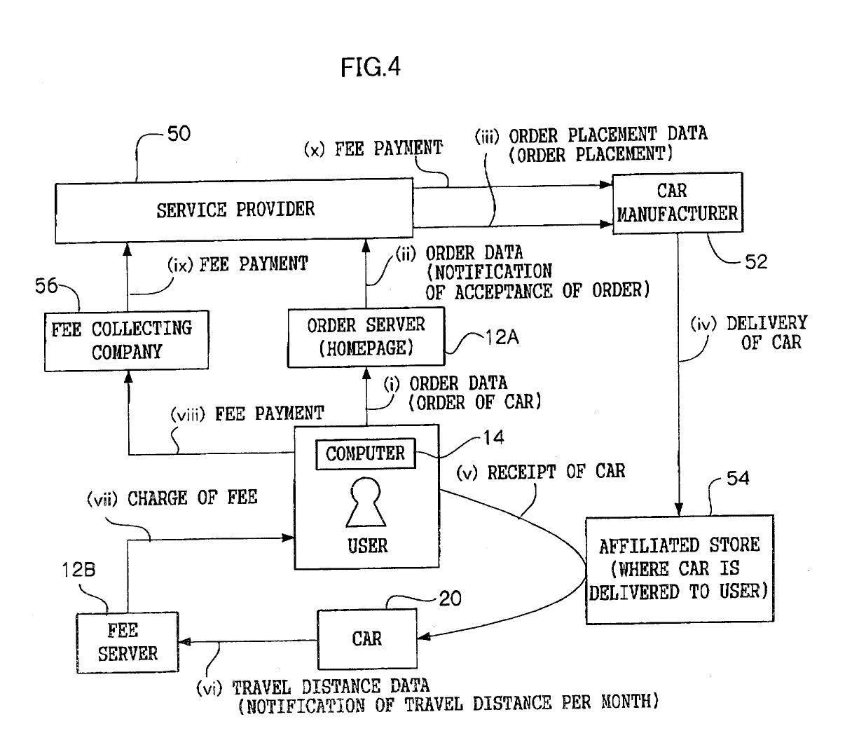

The servers 12 include an order server 12A for receiving an order for a car 20 (see FIG. 2) from a user of the computer 14 and a fee server 12B for charging a fee for the car 20 to the user. The order server 12A and the fee server 12B are controlled by a service provider 50 which provides marketing services (see FIG. 4).

The order server 12A and the fee server 12B may be respectively connected to the network 18 via the connecting means 16 as shown in FIG. 1 or via a LAN. In the present embodiment, the server devices of the present invention are formed by the two server devices, namely, the order server 12A and the fee server 12B. However, one server having the functions of both the order server 12A and the fee server 12B may be used as the server device of the present invention

The order server 12A and the computer 14 serve as a WWW (World Wide Web) server and a WWW client, respectively, in intercommunication therebetween via the network 18 (the Internet).

Namely, a WWW browser is installed on each of the computers 14. Starting the WWW browser provides arbitrary access to the order server 12A via the network 18. An access location (i.e., data formed by the locations of the servers 12 to be accessed and the location of information within the servers 12) is specified by a URL (Uniform Resource Locator).

When the computer 14 requests access to the order server 12A, the order server 12A transmits the data, which is at the location specified by a URL, via the network 18 to the computer 14 requesting the access. The data is generally transferred in accordance with the HTTP (Hyper Text Transfer Protocol).

The computer 14 uses the WWW browser to display the data, which has been transmitted from the order server 12A, on a display of the computer 14. (A so-called homepage or Web page is displayed.) Further, the computer 14 transmits various instructions or data, which have been inputted by the user with a mouse or a keyboard of the computer 14, to the servers 12 to be accessed.

In such communication via the network 18, the order server 12A transmits the data of a homepage for ordering a car to the computer 14 and receives order data from the computer 14. Further receipt of the order data by the order server 12A is notified to a homepage management company 50 which controls the order server 12A.

The fee server 12B includes a database in which information about the user who has placed an order for the car 20 with the order server 12A (i.e., customer information) is stored, and serves to calculate an amount of money to be charged to the user and charge the calculated amount to the user. In the present embodiment, a case in which the fee is charged by e-mail will be described as an example.

Specifically, the fee server 12B has the function of a mail server (so-called SMTP server). The data of an e-mail indicating the amount charged is transmitted to a predetermined mail server (not shown) which includes a mailbox of the user who has placed the order for the car with the order server 12A. The data is generally transferred in accordance with the SMTP (Simple Mail Transfer Protocol).

The mail server receives and stores the data of the e-mail in the mailbox of the user, and transmits the data stored in the mailbox for the user to the computer 14 when the user starts up e-mail client software (hereinafter referred to as “e-mail software”) by operating the keyboard or the mouse of the computer 14 such that the user gains access to the mail server and requests receipt of e-mails for the user. The data is generally transferred in accordance with the POP (Post Office Protocol) or the IMAP (Internet Message Access Protocol).

The computer 14 displays the data of the e-mail, which has been transmitted from the mail server, on the display of the computer 14 using the e-mail software. (Namely, the e-mail is displayed.) In this way, the fee is charged to the user.

The fee charged to the user by the fee server 12B is collected by computerized accounting (such as credit-card transaction) or a representative collecting telephone bills or the like (such as Calle of NTT Communications).

In the present invention, the method for charging the fee to the user (notifying the user of the amount charged) is not limited to the method using the e-mail. Besides the method using the e-mail, the fee may be charged to the user by using a service which delivers information to a mobile phone or a PHS (Personal Handy Phone) (such as i-mode by NTT DoCoMo, Inc.) to transmit the data of the amount from the fee server 12B to the user's mobile phone or PHS. Alternatively, the fee may be charged by sending to the user a postcard with the amount written thereon.

In the present embodiment, the expense for the car 20 itself is not charged to the user, but only a fee determined in accordance with monthly frequency of the use of the car 20 is charged to the user.

The fee is determined in accordance with a monthly travel distance (for example, Y 30/km). As will be described later in detail, the fee server 12B calculates a fee based on the distance that the car 20 has traveled in a month and charges the fee. Data of the travel distance, which is used for calculation of the fee, is transmitted from the car 20 delivered to the user to the fee server 12B every month. The fee does not need to be charged every month, but may be charged at predetermined time intervals.

Structure of Car

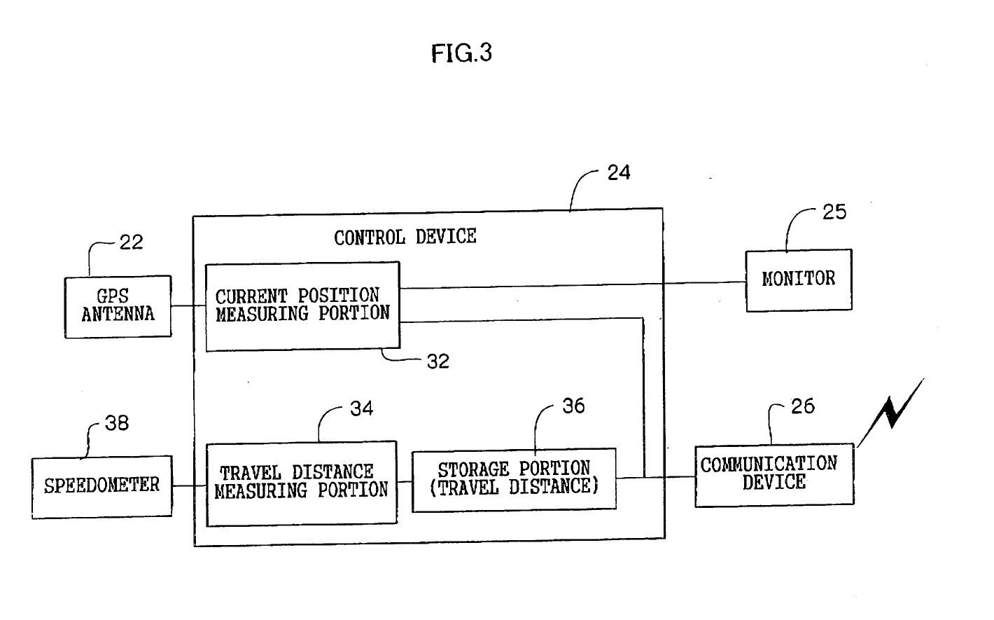

The structure of the car 20 will be described next. FIG. 2 is a schematic view showing a schematic structure of an interior of the car 20, and FIG. 3 is a block diagram showing a schematic structure of the car 20.

As shown in FIG. 2, a GPS antenna 22, a control device 24, a monitor 25, and a communication device 26 are mounted in the car 20. The control device 24 is connected to the GPS antenna 22, the monitor 25, and the communication device 26 via predetermined cords 28, 29, and 30, respectively.

The GPS antenna 22 receives radio waves from GPS satellites (not shown) and transmits the radio waves to the control device 24.

As shown in FIG. 3, the control device 24 includes a current position measuring portion 32 for measuring a current position of the car 20, a travel distance measuring portion 34 for measuring a distance that the car 20 has traveled, and a storage portion 36.

Non-volatile storage elements are used in the storage portion 36 for storing programs within the control device 24, and upgrade programs for Java applications and systems are stored in the storage portion 36. Java application programs can be upgraded as needed by the upgrade programs in accordance with information delivered from the servers 12. SmartMedia, CompactFlash, a hard disk, or the like can be used as a storage medium.

The current position measuring portion 32 determines the current position of the car based on radio waves from the GPS satellites. Specifically, the GPS antenna 22 receives radio waves (representing information on the orbit and the time) from three or four GPS satellites. The current position measuring portion 32 analyzes every radio wave received and determines an amount of time required for the radio waves from each of the GPS satellites to reach the car. The current position of the car is determined by calculating a distance between the car and each of the GPS satellites based on the determined time. For example, a CD-ROM having map information recorded thereon is loaded in a CD-ROM drive (not shown), and the current position of the car is displayed on the monitor 25 together with the map information read out from the CD-ROM.

Namely, the GPS antenna 22, the monitor 25, and the current position measuring portion 32 are used to inform an occupant of the current position of the car or to form a navigation system for guiding the car to a destination. It suffices if the present invention can measure the current position of the car by using the GPS, and the navigation system is not essential.

From information on the traveling speed of the car 20 which is measured by a speedometer 38 normally mounted in a car, the travel distance measuring portion 34 determines the distance that the car 20 has traveled, and the result is added and stored in the storage portion 36. Namely, data representing the cumulative travel distance is stored in the storage portion 36.

The distance that the car 20 has traveled can also be determined from changes in the current position of the car 20 which has been determined by the current position measuring portion 32. However, the travel distance is preferably determined from the traveling speed measured by the speedometer 38 since a commercial GPS (information represented by radio waves from GPS satellites) has a deliberately decreased accuracy and a travel distance which is determined from changes in the current position does not correspond to the distance that the car has actually traveled in the case of curved roads or the like.

Every month, the communication device 26 reads the data representing the cumulative travel distance stored in the storage portion 36, and transmits the data to the fee server 12B together with the data representing the current position of the car 20 determined by the current position measuring portion 32. Specifically, the data is transmitted by wireless from the communication device 26 to the communication server 15, and then transmitted from the communication server 15 via the network 18 (Internet) to the fee server 12B. Namely, the control device 24 and the fee server 12B are connected to each other via wired and wireless networks.

The present embodiment uses a dedicated communication terminal for communicating with a low-earth-orbit satellite (such as Orbcomm manufactured by ORBCOMM Japan Ltd.) which provides a GPS service and a two-way data communication service. The two-way data communication service is used to realize two-way communication by which the communication device 26 transmits and receives various data to and from the low-earth-orbit satellite. In this way, the communication device 26 can achieve two-way communication with the devices connected to the network 18 via the communication server 15 and the low-earth-orbit satellite. Further, the GPS antenna uses the GPS service provided by the low-earth-orbit satellite to receive radio wave information which is used to measure the current position of the car 20.

The communication device 26 is not limited to the dedicated communication terminal for communicating with the low-earth-orbit satellite, and any device can be used as long as it has at least the function of receiving information. For example, the communication device 26 may be a PHS, a mobile phone, or the like. Further, the cdma method or the W-CDMA method conforming to the IMT-2000 (International Mobile Telecommunications 2000) standard can also be used as the transmission method.

The content of the storage portion 36 is set back to its initial value (0) after the storage portion 36 has transferred data to the communication device 26. With this structure, the monthly travel distance is notified to the fee server 12B every month.

Operation

Next, operation of the present embodiment will be described with reference to FIGS. 4 to 6.

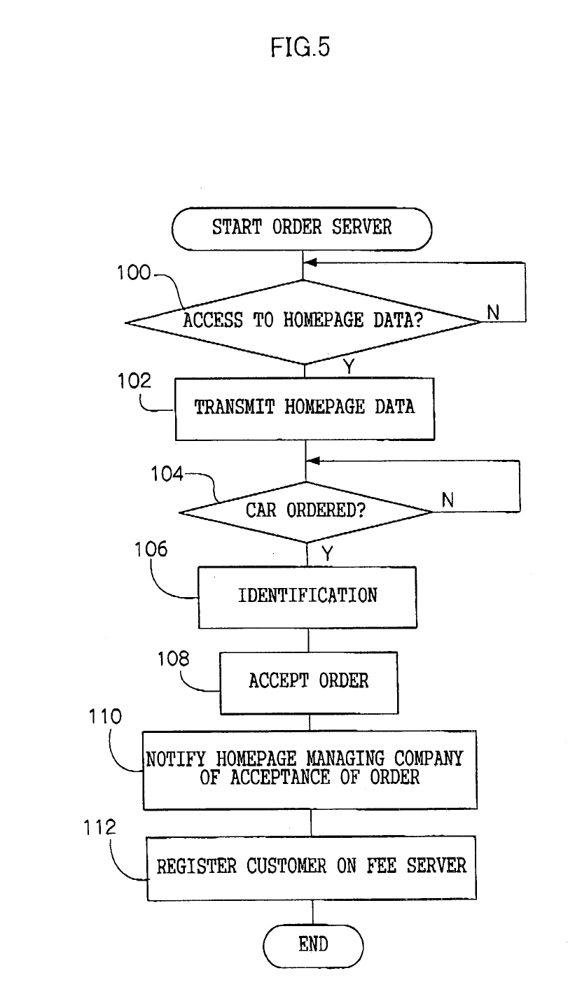

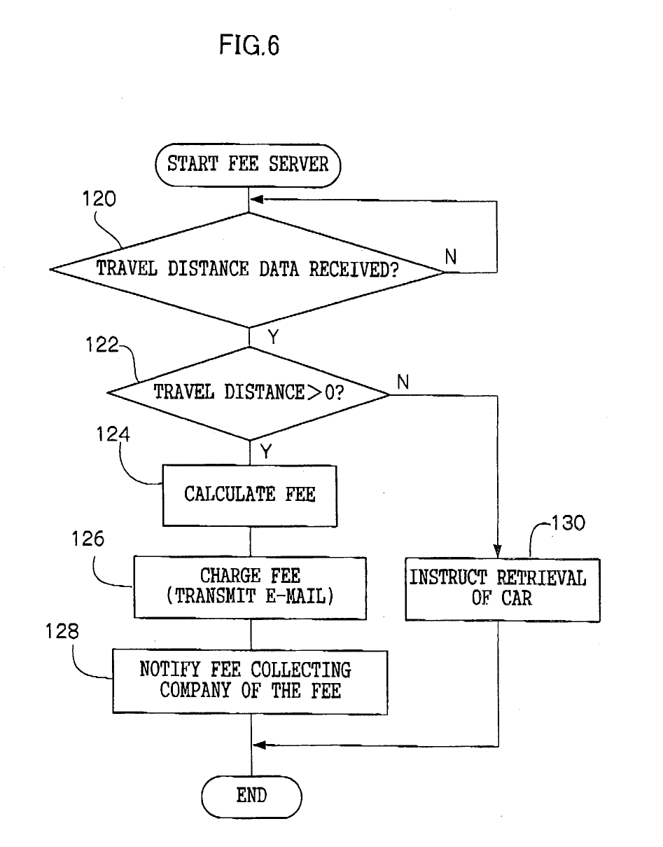

FIG. 4 shows a flow of all marketing services, namely, the flow of a process starting from a user ordering the car 20 via the network and driving the delivered car 20, and ending with the user paying a fee. FIG. 5 is a flow chart of processing executed by the order server 12A, and FIG. 6 is a flow chart of processing executed by the fee server 12B. The following description will be given in the order of arrows (i), (ii), (iii), . . . , and (x) in FIG. 4.

(i) The user orders the car 20 by transmitting order data to the order server 12A via the network 18.

Specifically, when the user orders the car 20, the user first accesses, from the computer 14, the data of the homepage for ordering the car 20, which data is stored in the order server 12A. (Namely, the user accesses the homepage.)

As shown in FIG. 5, when the user accesses the data of the homepage for ordering the car 20 (step 100), the processing proceeds to step 102 where the order server 12A transmits the data of the homepage to the computer 14 accessing the homepage. The processing then proceeds to step 104 where the order server 12A is placed in a stand-by state until the car is ordered.

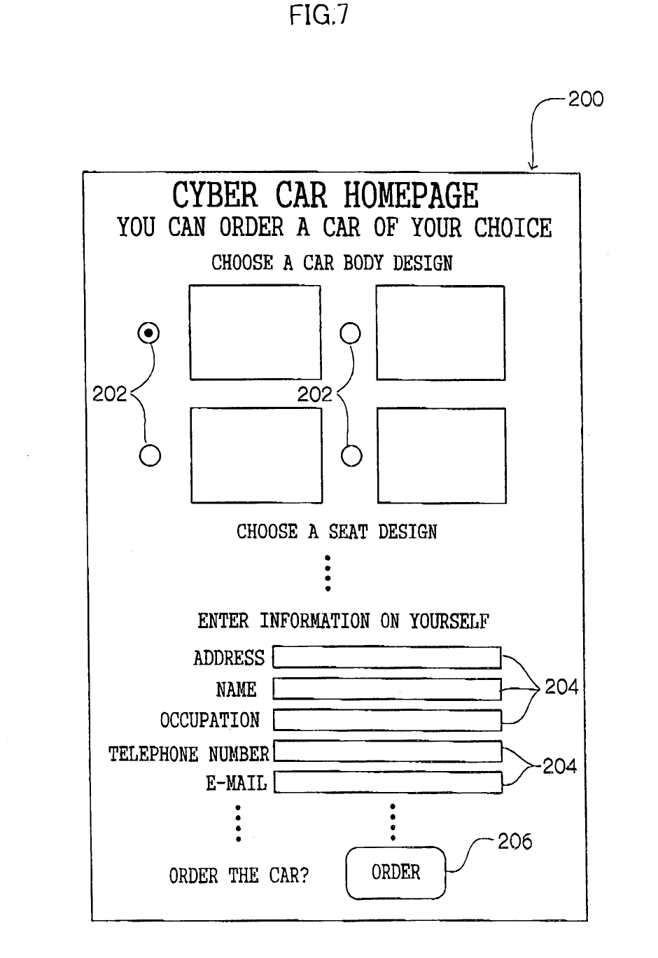

A screen 200 of the homepage for ordering a car is displayed on the display of the user's computer 14. FIG. 7 is an example of the homepage screen 200.

The homepage screen 200 shown in FIG. 7 is structured so that the user can choose a car body and seat designs from plural types of designs by clicking on check boxes 202. Further, character entry columns 204 for entering user information (customer information) and an “order” button 206 are provided on the homepage screen 200. User information to be entered includes the user's name, the user's address, information (such as credit card number) for identification which will be described later, and the user's e-mail address for charging.

After the user has clicked on or off the check boxes 202 and selected his/her desired type by operating the mouse or the like of the computer 14, the user enters customer information in the character entry columns 204. Subsequently, the user clicks on the “order” button 206 to order a car of his/her desired design. When the “order” button 206 is clicked, the order data including the result of selection of the desired car type and the customer information is transmitted from the computer 14 to the order server 12A.

(ii) As shown in FIG. 5, the order server 12A receives the order data and determines that a car has been ordered, and the processing proceeds to subsequent step 106. In step 106, identification of the user is carried out using the user's information included in the order data. Subsequently, the processing proceeds to step 108 where the order for the car by the user is accepted.

At this time, information on an affiliated store 54 (such as a beauty shop, a convenience store, or the like) located nearest to the user is transmitted to the computer 14 so that the user is notified of the affiliated store 54.

If identification fails, the order is not accepted. It is preferable that a message or the like be displayed on the display of the computer 14, informing the user that identification has failed and thus the order cannot be accepted.

When the order for a car by the user is accepted, the processing proceeds to subsequent step 110 where the order server 12A transmits the order data to a service provider 50 and notifies it of the acceptance of the order. At the same time, in subsequent step 112, the order server 12A transmits the user information to the fee server 12B, which registers the user as a customer.

(iii) Upon notification of the acceptance of the order, the service provider 50 generates order placement data based on the order data, and sends the order placement data to a car manufacturer 52 to place an order for manufacture of the car 20 with the car manufacturer 52. This can be achieved by, for example, transmitting the order placement data from a computer of the service provider 50 to a computer of the car manufacturer 52.

(iv) The car manufacturer 52 manufactures the car based on the order placement data and transports (delivers) the car to the affiliated store 54 nearest to the user.

(v) The user goes to the affiliated store 54 nearest to the user to receive the car. The user does not pay for the car itself but covers all other expenses such as insurance.

When the marketing services become prevalent and a large number of people purchase a car by using the marketing services, the insurance fee for the user can be reduced by obliging the user to purchase group insurance from a predetermined insurance company in accordance with a rule approved by the user when the user purchases a car by using the marketing services. Specifically, the applicant confirms that, when a person of age 18 to 24 purchases various types of insurance such as collision insurance, personal injury liability insurance, property damage liability insurance, and the like with a total coverage of three to four million yen, an annual insurance premium is 300,000 to 400,000 yen in the case of an individual contract, but is 100,000 to 120,000 yen, for example, if thousands of people join a group contract. The applicant also confirms that the insurance premium is further reduced if the user purchases a three-year insurance package.

In this way, the car 20 is freely driven by the user after having been delivered to the user. The distance that the car 20 has traveled is measured by the travel distance measuring portion 34 of the control device 24 as needed, and added and stored in the storage portion 36.

(vi) The data (i.e., data of the travel distance) stored in the storage portion 36 is transmitted every month from the car 20 to the fee server 12B by the communication device 26, and the content of the storage portion 36 is reset after the transmittance of the data. Namely, the monthly travel distance is notified to the fee server 12B. Information on the current position of the car 20 determined by the current position measuring portion 32 is also transmitted to the fee server 12B and used for the control of the car 20 after the car 20 has been delivered to the user (for example, for the purpose of preventing misuse of the car 20, grasping promotional effect of the car 20 from the distribution of the cars 20 in a city, and the like).

(vii) As shown in FIG. 6, the fee server 12B is placed in a stand-by state until the travel distance data is transmitted thereto (step 120). When the fee server 12B receives the travel distance data from the car 20, the processing proceeds to step 122. In step 122, the fee server 12B checks whether the car 20 was used at all in the past month (i.e., whether the travel distance >0). Subsequently, the processing proceeds to step 124 where the fee server 12B calculates a fee based on the travel distance in the past month.

Specifically, in the present embodiment, the fee is calculated based on, for example, the following calculation method. When the new car 20 is delivered to the user, the user does not pay for the car 20 itself. After three years, the car 20 is returned by the user and brought over to the secondhand car market or the like so that the remaining value of the car 20 is amortized. The amount of money obtained by subtracting the remaining value of the car 20 after three years from the price of the car 20 at the present moment (i.e., when the car 20 is new) is charged to the user based on the travel distance. The reason why the remaining value of the car 20 is amortized after three years is that new-model cars are generally released (introduced) every three years and the car 20 of the previous model has no promotional effects after the release of new-model cars.

Thus, assuming that the price of the car at the present moment is P1 (yen), the remaining value of the car 20 after three years is P2 (yen), and the average monthly travel distance is LA (km), Pu, the unit price per km, is calculated as follows.

Pu=(P1−P2)÷36 months÷LA

Assuming that the monthly travel distance is L (km), the price P is calculated from P=Pu×L. The average monthly travel distance LA is set after research.

When the user who already owns a car before purchasing the car 20 by using the marketing services, the car owned by the user may be traded in for the car 20, and the trade-in price may be subtracted from the unit price. In this case, assuming that the trade-in price is P3, the fee is calculated based on the unit price per km, i.e., Pu, which is obtained by the following formula.

Pu=(P1−P2−P3)÷36 months÷LA

After the fee has been calculated as described above, the processing proceeds to subsequent step 126 where the fee server 12B charges the calculated fee to the user by e-mail. At the same time, in subsequent step 128, the fee server 12B notifies a fee collecting company 56 (such as a telephone company, a credit card company, or the like) of the fee and requests the company 56 to collect the fee from the user.

When the user has not used the car 20 for a month (i.e., when the determination in step 122 is negative), the fee server 12B instructs the car manufacturer 52 to retrieve the car 20 (step 130). This can be carried out by, for example, transmitting a signal representing the instruction from the fee server 12B to a computer of the car manufacturer 52.

(viii) The user pays the charged fee to the fee collecting company 56.

(ix) The fee collecting company 56 pays to the car manufacturer 52 an amount of money obtained by subtracting commission (several percents) from the fee received from the user.

(x) The service provider 50 pays to the car manufacturer 52 an amount of money obtained by subtracting commission (several percents) from the fee received from the fee collecting company 56.

In this way, in the present embodiment, the order for the car 20 is received from the user via the network. The expense for the car 20 is free for the user, and only the fee for using the car 20 is collected from the user. By using the marketing services, the user has an advantage that he/she can obtain a car easily and for free, and many people will use the services. The car manufacturer 52 can obtain effects similar to those of advertisement on TV commercials and the like because the cars receive people's attention if a large number of the cars travel in the city.

In other words, advertisement expenses for TV commercials and the like can be reduced, and therefore, the expense for the car (i.e., the sales price) can be reduced accordingly. The car 20 can also be provided free of charge as described above.

Further, since it is not necessary to sell cars over the counter, dealers do not need to be showrooms, and it suffices if affiliated stores where cars are delivered to users are obtained. This is particularly effective for overseas car manufacturers which do not have dedicated dealers. This enables reduction in the maintenance fee and the expense for a car.

In view of the fact that dealers are managed not only by selling new cars but also by insurance, car inspection, semiannual and annual checkups, and the like, widening the scope is considered to be the most essential. Increase in the number of cars sold by the above-described car sales method is substantially beneficial to the existing dealers as well.

The above-described method also has an effect of restraining the user from unnecessarily using the car 20 by charging the fee to the user in accordance with the travel distance. Therefore, the method can cope with the environmental problems as well.

If the car 20 is not used, promotional effects cannot be obtained. Thus, the car 20 which has not been used for a month is retrieved from the user, thereby preventing the advertisement fee (such as the expense for the car which are covered by the car manufacturer, and the like) from wasting. It is beneficial if the retrieved car 20 is brought over to the secondhand car market. Whether the car 20 should be retrieved or not can be determined based on the usage thereof within a predetermined period. The period is not limited to one month but may be two or three months.

Further, after new-model cars have been released, the car 20 of old type has no promotional effects. Therefore, it is advantageous that the car 20 is purchased by the user or retrieved and brought over to the secondhand car market when a predetermined period of time (e.g., three years) has elapsed since the car was delivered to the user.

Although the expense for the car is free for the user in the above description, the present invention is not limited to the same. By the sales via the network, it is essential to reduce the advertisement fee by increasing the number of cars sold (i.e., the number of cars distributed in the city) and thus obtaining promotional effects, and to the reduce the maintenance fee for the offices, such that the expense for the car is reduced more than is possible with conventional art.

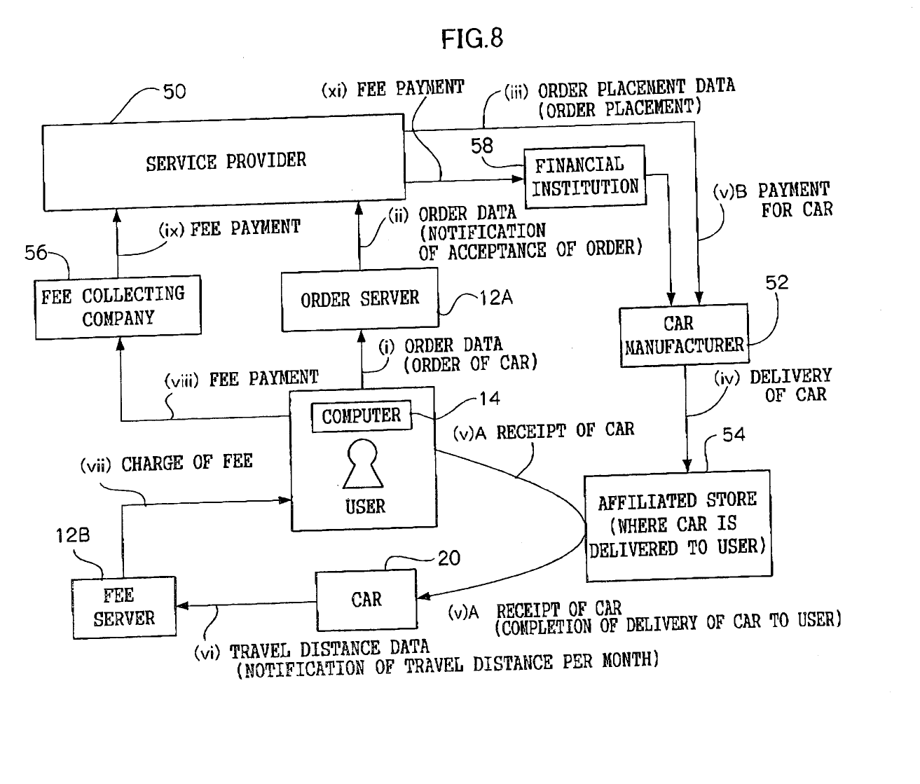

Namely, the expense for the car may be paid to the car manufacturer 52, and an example of such a case is shown in FIG. 8. In FIG. 8, a financial institution 58 such as a bank pays the car manufacturer 52 for the car. The owner of the car 20 is the financial institution 58, and the user of the car 20 is the user of the computer 14. Members and processes in FIG. 8 which are the same as those in FIG. 4 are designated by the same reference numerals, and detailed description thereof will be omitted.

Specifically, when delivery of the car to the user is completed (see arrow (v)A), the financial institution 58 pays the car manufacturer 52 for the car 20 (see arrow (v)B). Subsequently, the user drives the car around and, as described above, a fee is charged to the user by the fee server 12B in accordance with the travel distance (see arrows (vi) and (vii)). The user pays the charged fee to the fee collecting company 56 (see arrow (viii)), and an amount of money obtained by subtracting commission (several percents) from the fee collected from the user are paid by the fee collecting company 56 to the service provider 50 (see arrow (ix)), and an amount of money obtained by subtracting commission (several percents) from the fee collected from the fee collecting company is paid by the service provider 50 to the financial institution 58 (see arrow (xi)).

A case in which the data representing the travel distance is transmitted by the communication device 26 from the car 20 to the fee server 12B in order to charge the fee is described above. However, the transmission function of the communication device 26 may be used to transmit the data representing the state of the car 20 (hereinafter referred to as the “state data”) from the car 20 to the car manufacturer 52 for research and development of the car body. An example of such a case will be described below as a second embodiment.

### Second Embodiment

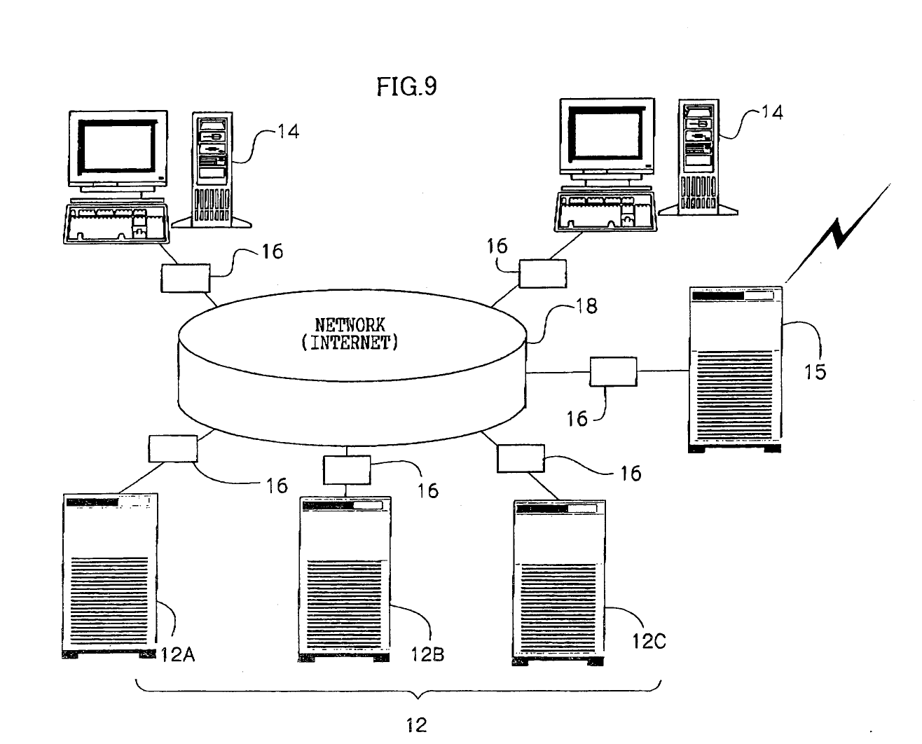

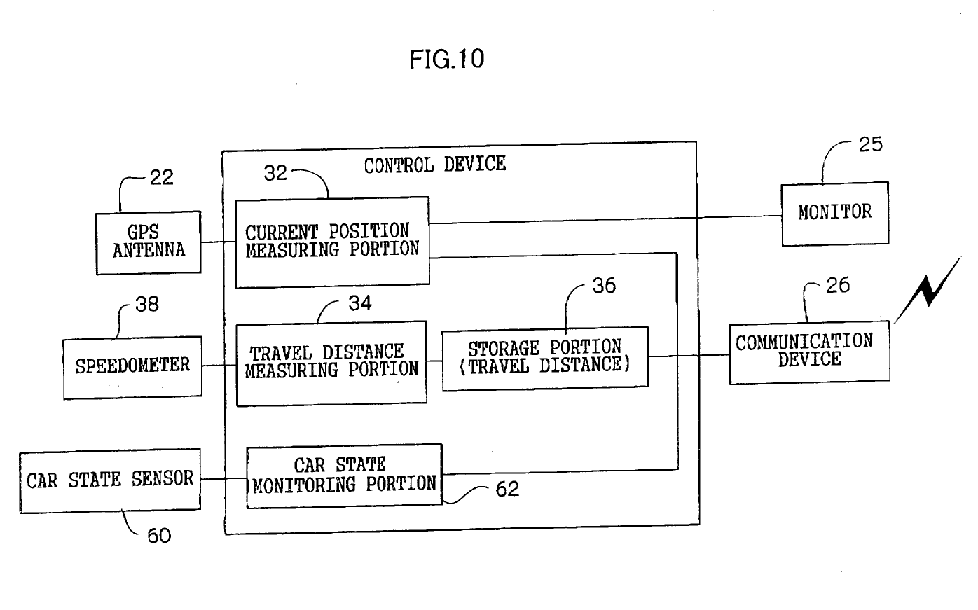

FIG. 9 shows the schematic structure of a network system according to the second embodiment. Further, FIG. 10 is a block diagram showing the schematic structure of the car 20 according to the second embodiment. Members in FIGS. 9 and 10 which are the same as those of the first embodiment are designated by the same reference numerals, and detailed description thereof will be omitted.

As shown in FIG. 9, the second embodiment is structured such that a data collecting server device (hereinafter referred to as the “data collecting server”) 12C is added to the structure of the first embodiment as one of the servers 12 and connected via the connecting means 16 to the network 18. The data collecting server 12C can communicate with the other devices connected to the network 18 and can also communicate, via the communication server 15 and the low-earth-orbit satellite, with the communication device 26 mounted in the car 20. Further, as well as the order server 12A and the fee server 12B, the data collecting server 12C is controlled by the service provider 50.

As well as the order server 12A and the fee server 12B, the data collecting server 12C may be connected via the LAN to the network 18 by being connected to the LAN which is in turn connected to the network 18. Further, a case in which the server devices of the present invention (see claim 12 for details) are formed by the three server devices, namely, the order server 12A, the fee server 12B, and the data collecting server 12C is described in the present embodiment. However, one server device having the functions of the order server 12A, the fee server 12B, and the data collecting server 12C may be used as the server device of the present invention.

As shown in FIG. 10, a car state sensor 60 for detecting the state of the car 20 is installed at the car 20 and connected to the control device 24. Further, a car state monitoring portion 62 is additionally provided at the control device 24. The car state monitoring portion 62 monitors the state of the car 20 based on the results of the detection by the car state sensor 60, and the results of the monitoring are transmitted from the communication device 26 as state data.

In the present embodiment, specifically, data representing the engine speed, braking frequency, and frequency at which a steering wheel is turned (operated) is obtained as the state data. The state data may be a combination of two or more of the engine speed, the braking frequency, the steering wheel operation frequency, and the travel distance.

In order to obtain the engine speed as the state data, it is preferable that a sensor, which is generally mounted in a normal car to detect the engine speed, is used as the car state sensor 60 and the engine speed is monitored (counted) at the car state monitoring portion 62. Further, in order to obtain the braking frequency, it is preferable that a sensor for detecting whether a brake pedal has been pressed down is provided near the brake pedal and the breaking frequency is monitored (counted) at the car state monitoring portion 62. Furthermore, in order to obtain the number of times of handle operations, it is preferable that a sensor for detecting whether a handle has been rotated to a predetermined angle or more is provided at or near the handle and the number of times of handle operations is monitored (counted) at the car state monitoring portion 62.

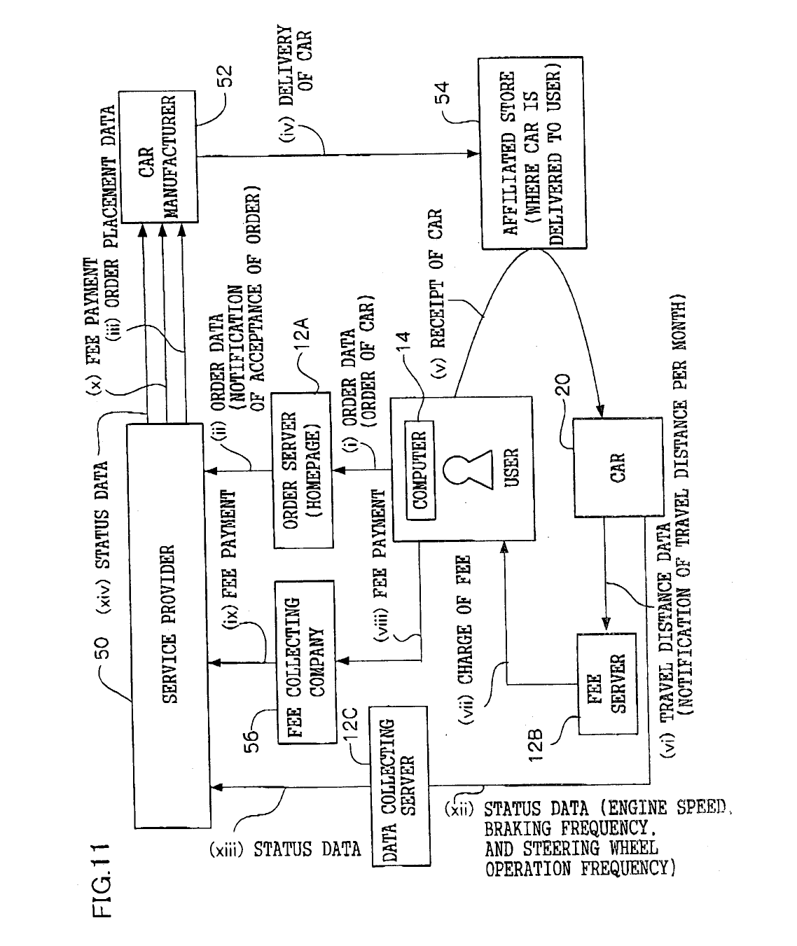

Next, operation of the second embodiment will be described. FIG. 11 shows the flow of entire marketing services according to the second embodiment. Members and processes in FIG. 11 which are the same as those in FIG. 4 are designated by the same reference numerals, and detailed description thereof will be omitted.

As shown in FIG. 11, in the second embodiment, after the car 20 has been delivered to the user (see arrow (v)), the data representing the travel distance is transmitted every month from the car 20 to the fee server 12B by the communication device 26, and the fee determined in accordance with the travel distance is paid (see arrows (vi) to (x)). At a predetermined timing (such as at the time of transmitting the data representing the travel distance, at regular intervals such as every month, or at irregular intervals such as when a transmission request is received), the state data is transmitted from the car 20 to the data collecting server 12C by the communication device 26 (see arrow (xii)). The data collecting server 12C collects the state data which has been transmitted from each of the cars 20 and collectively sends the data to the service provider 50 (see arrow (xiii)), and the data is in turn provided from the service provider 50 to the car manufacturer 52 (see arrow (xiv)). The state data may be transmitted from the car 20 directly to the car manufacturer 52 (specifically, to a predetermined server device or a computer connected to the network 18 and controlled by the car manufacturer 52) instead of being transmitted to the car manufacturer 52 via the service provider 50.

The car manufacturer 52 uses the state data, which has been provided from the service provider 50 as described above, for research and development of the car body.

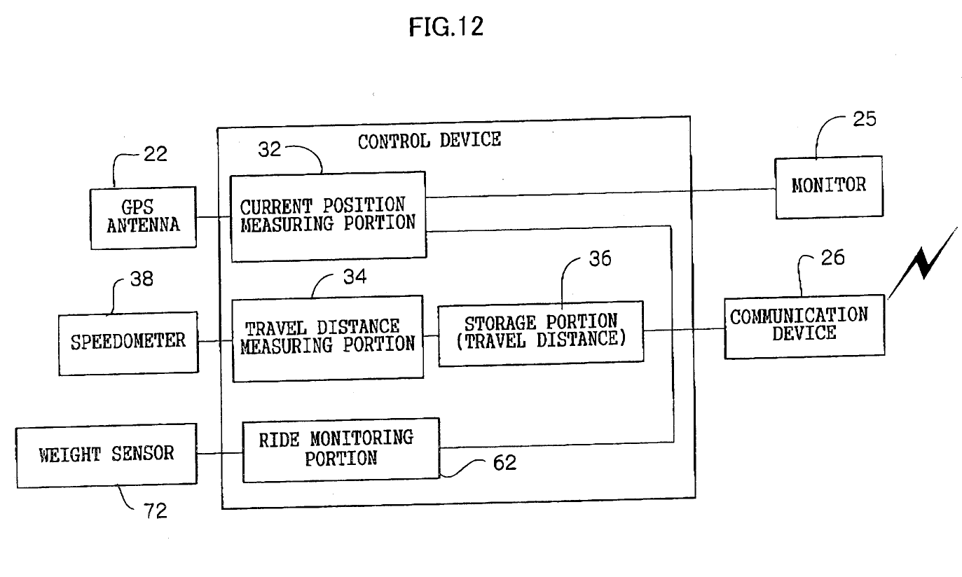

When the car 20 is a taxi, data of whether a passenger is present or not may be transmitted from the car 20 to a taxi company and used for the operational control of taxis. In this case, the car 20 may be structured, for example, as shown in FIG. 12.

Namely, a weight sensor 72 for detecting weight is provided at a passenger seat inside the car 20 and connected to the control device 24. Further, a ride monitoring portion 74 is additionally provided at the control device 24. When the weight sensor 72 detects, for example, the weight of a predetermined value or more, the ride monitoring portion 74 monitors the presence of a passenger based on the results of the detection by the weight sensor 72 and, for example, determines that a passenger is in the car. Subsequently, the monitoring results, ID information provided for each car (taxi) 20 in advance, and data of the travel distance of the car 20 with a passenger therein may be transmitted from the communication device 26 as ride data. Members in FIG. 12 which are the same as those in FIG. 3 are designated by the same reference numerals.

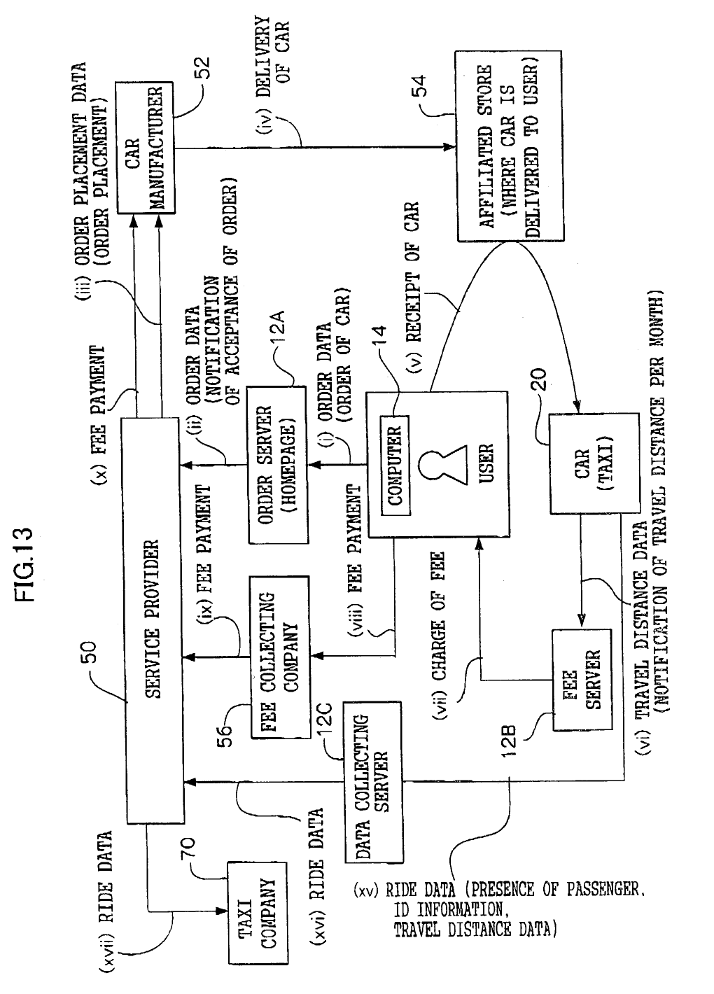

In this case, as shown in FIG. 13, after the car 20 has been delivered to the user (see arrow (v)), the data representing the travel distance is transmitted every month from the car 20 to the fee server 12B by the communication device 26, and the fee determined in accordance with the travel distance is paid (see arrows (vi) to (x)). At a predetermined timing (such as when a passenger gets on or off the car, at regular intervals such as every month, or at irregular intervals such as when a transmission request is received), the ride data is transmitted from the car 20 to the data collecting server 12C by the communication device 26 (see arrow (xv)). The data collecting server 12C collects the state data which has been transmitted from each of the cars 20 and collectively sends the data to the service provider 50 (see arrow (xvi)), and the data is provided from the service provider 50 to the car manufacturer 52 (see arrow (xvii)). The ride data may be transmitted from the car 20 directly to the taxi company 70 (specifically, to a predetermined computer connected to the network 18 and controlled by the taxi company 70) instead of being transmitted thereto via the service provider 50.

The taxi company 70 uses the ride data provided from the service provider 50 to control the operation of the car (taxi) 20. In this way, the operational control can be accurately and simply carried out. Further, if information representing the positions where a passenger got on and off the car, which positions are measured by the GPS, is transmitted as the ride data, the taxi company 70 can grasp the positions where the passenger got on and off the car and easily prepare a daily driving report for each of the cars (taxis) 20 by using the ride data.

As described above, in the present second embodiment, the communication device 26 having the transmitting and receiving functions is used and enables two-way communication. Therefore, the fee to be paid by the user may be decreased by covering the fee with an advertisement fee collected from an advertiser when the user views or hears advertisements such as video advertisements outputted on the monitor 25, audio advertisements outputted from speakers, or animated advertisements which are the combinations of the video and audio advertisements. A specific example will be described below as a third embodiment.

### Third Embodiment

Members of the present third embodiment which are the same as those of the above-described embodiments are designated by the same reference numerals, and detailed description thereof will be omitted.

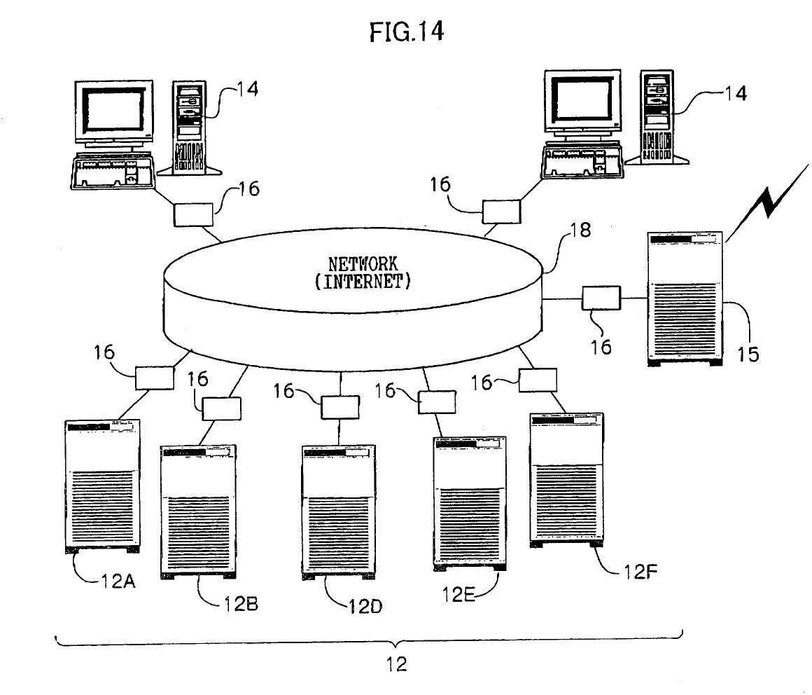

As is schematically shown in FIG. 14, a network system according to the present third embodiment is structured such that a car position control server 12E for collecting and controlling data representing the current position of the car 20, an advertisement transmission server 12D for transmitting to the car 20 advertising information on an area around the current position of the car 20, and an emergency information transmission server 12F for delivering emergency information in case of an emergency such as a disaster or an earthquake are added as servers 12 to the structure of the first embodiment and additionally connected to the network 18 via the connecting means 16 such as routers. Information on various advertisements is registered on the advertisement transmission server 12D so as to correspond to information on an area (such as an area “b-2” in FIG. 7 which will be described later) for specifying an area to which the advertisements are delivered. The car position control server 12E, the advertisement transmission server 12D, and the emergency information transmission server 12F can communicate with the other devices connected to the network 18 and can also communicate, via the communication server 15 and the low-earth-orbit satellite, with the communication device 26 mounted in the car 20. Further, as well as the order server 12A and the fee server 12B, the car position control server 12E, the advertisement transmission server 12D, and the emergency information transmission server 12F are controlled by the service provider 50.

As well as the order server 12A and the fee server 12B, the car position control server 12E, the advertisement transmission server 12D, and the emergency information transmission server 12F may be connected via the LAN to the network 18 by being connected to the LAN which is in turn connected to the network 18. Further, a case in which the five server devices, namely, the order server 12A, the fee server 12B, the car position control server 12E, the advertisement transmission server 12D, and the emergency information transmission server 12F are used is described in the present embodiment. However, one server device having the functions of the order server 12A and the fee server 12B may be used.

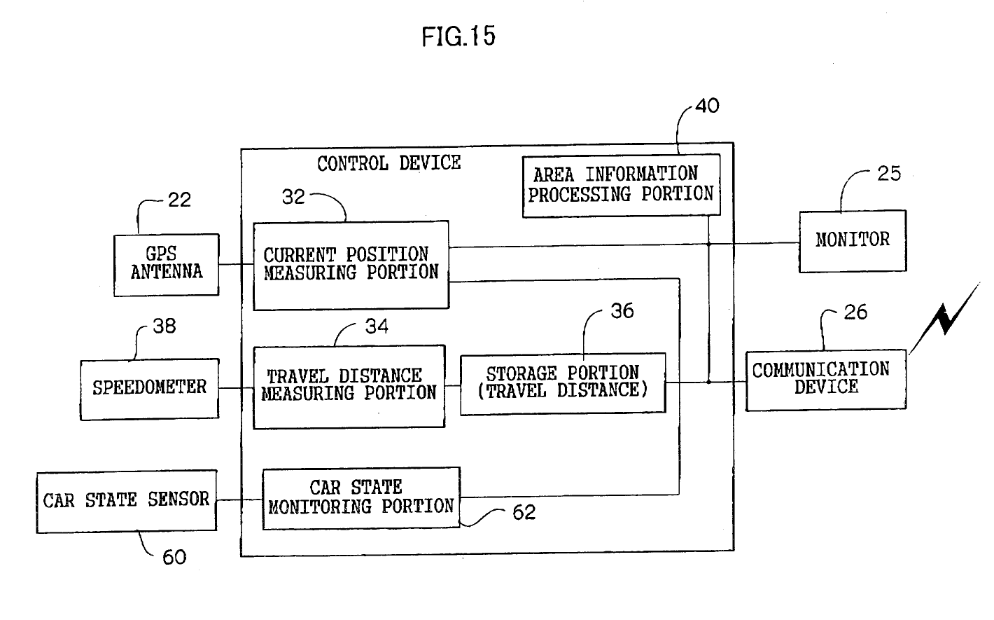

As shown in FIG. 15, an area information processing portion 40 is further provided inside the control device 24. The area information processing portion 40 is connected to the monitor 25 and the communication device 26.

Next, operation of the present third embodiment will be described.

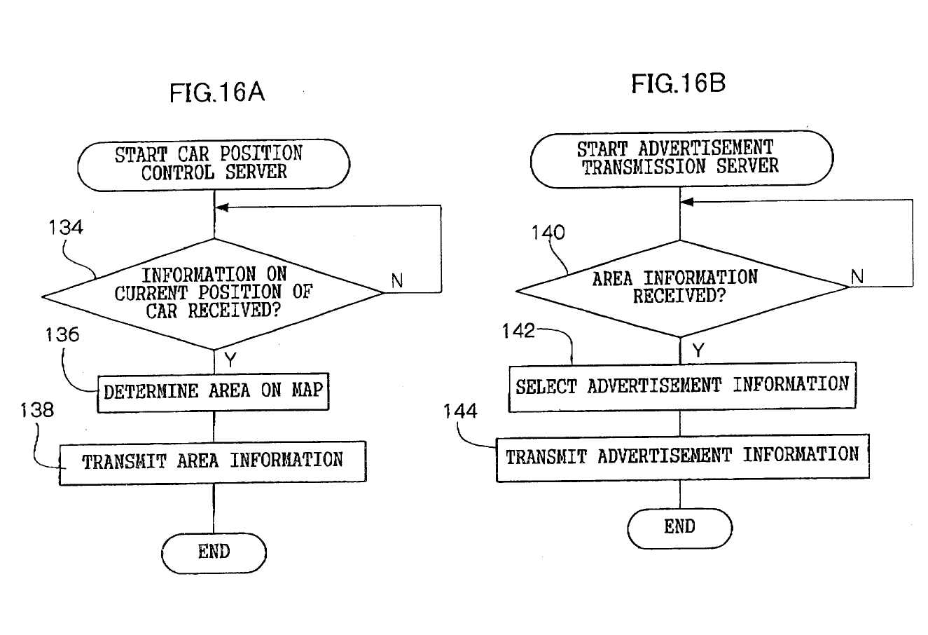

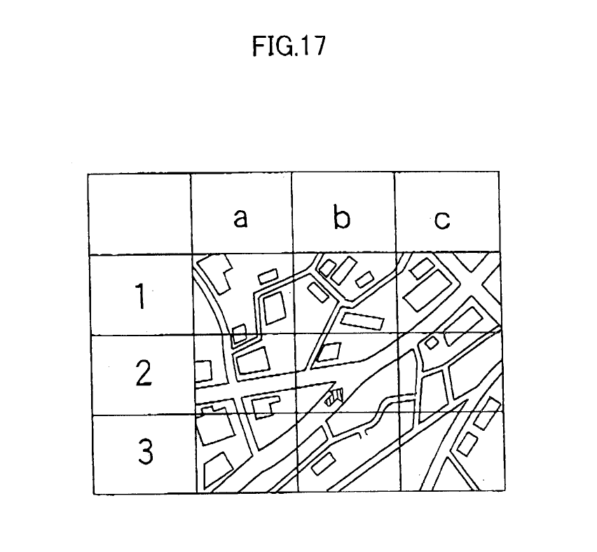

When the car 20 is started and the communication equipment mounted therein is turned on, the car position control server 12E starts area information transmission processing shown in FIG. 16A in order to transmit area information to the advertisement transmission server 12D. In step 134, the car position control server 12E is placed in a stand-by state until the server 12E receives information on the current position of the car, which information is transmitted from the communication device 26 of the traveling car 20. Upon receiving information on the current position of the car 20, the car position control server 12E determines an area on a map which corresponds to the information. Namely, since the car position control server 12E controls the information on the current position of the car based on each of areas on a matrix-shaped map as shown in FIG. 17, the car position control server 12E determines the area on the map in which the car 20 is traveling by using the received information on the current position of the car 20. For example, since the car 20 is traveling in the area b-2 on the map in FIG. 17 (indicated by an arrow), the car position control server 12E verifies that the area in which the car 20 is traveling is the area b-2. Subsequently, the car position control server 12E transmits information on the verified area to the advertisement transmission server 12D, whereby the processing ends.

Advertisement transmission processing shown in FIG. 16B is executed by the advertisement transmission server 12D. In step 140, the advertisement transmission server 12D is placed in a stand-by state until receiving the area information transmitted from the car position control server 12E. Upon receiving the area information, in step 142, the advertisement transmission server 12D selects advertisement information corresponding to the area information from advertisement information registered in advance. For example, when the area information is “b-2”, the advertisement transmission server 12E selects information registered as the advertisement information on the area “b-2”. Subsequently, the advertisement transmission server 12 delivers the selected advertisement information to the car 20 in step 144, whereby the processing ends.

The selection of advertisement information in step 142 can also be carried out in view of passenger data (such as age, gender, family makeup, and the like of a passenger), which is obtained in advance from the user of the car 20.

The advertisement information delivered from the advertisement transmission server 12D is transmitted via the network 18 to the communication server 15 and transmitted therefrom to the car 20 via the low-earth-orbit satellite. The advertisement information is received by the communication device 26 of the car 20. The received advertisement information is outputted to the monitor 25 or from a speaker while being controlled by the area information processing portion 40.

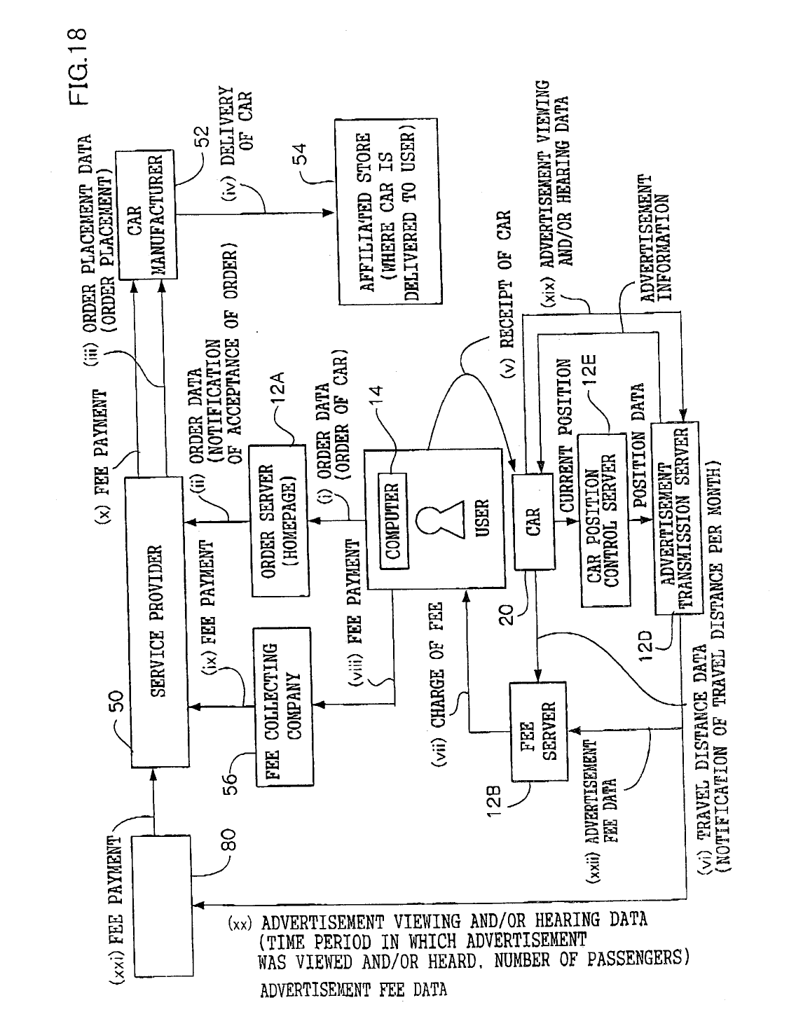

Further, an advertisement fee is charged via the network to the advertiser, which provides the advertisement information delivered to the car 20. The advertisement fee is charged in accordance with the time period during which the advertisement information is displayed on the monitor 25 of the car 20 or the number of passengers obtained by the car state sensor 60. A specific flow of charging the advertisement fee is shown in FIG. 18.

For each advertisement, the area information processing portion 40 transmits to the advertisement transmission server 12D advertisement viewing and/or hearing data, which represents the time period during which the transmitted advertisement information was viewed and/or heard in the car 20 and the number of people who viewed and/or heard the advertisement information (xix). The advertisement transmission server 12D calculates the advertisement fee based on the advertisement viewing and/or hearing data, transmits data of the advertisement fee and the advertisement viewing and/or hearing data via the network to the advertiser 80, and charges the advertisement fee (xx). The advertiser 80 pays the charged fee to the service provider 50 (xxi). The advertisement transmission server 12D also transmits the advertisement fee data to the fee server 12B (xxii). The fee server 12B reduces the fee to be paid by the user based on the advertisement fee data and charges to the user a fee obtained after the reduction (vii).

In the present embodiment, the fee to be paid by the user is reduced by an amount corresponding to the advertisement fee. Alternatively, the user may obtain supplementary income by viewing and/or hearing many advertisements.

Further, the user of the car 20 can request, via the network, advertisement information to be delivered. For example, the user can obtain music information and listen to a tune in the car by selecting the tune in response to information on titles of tunes delivered from the advertisement transmission server 12D. The user can also send a feedback by making remarks about the tune in the form of a questionnaire.

A dedicated speaker installed inside the car 20, a speaker included in the monitor 25, or a speaker originally mounted in the car can be used as the speaker for outputting the advertisement information. The speaker is connected to the control device 24 in advance.

Further, in the present embodiment, the advertisement information is usually delivered as described above. However, emergency information is delivered from the emergency information transmission server 12F to a car traveling in or towards an area where an earthquake or a disaster has occurred. The emergency information is received by the communication device 26, and the area information processing portion 40 outputs the emergency information, instead of the advertisement information, to the monitor 25 or the speaker. In this way, the car can be guided to a safe zone by images and/or sound.

Although the above description has been given assuming that the car 20 is a common car or taxi, the car 20 may be other type of car. Particularly, if the present invention is applied to the sales of cars for nursing care and amnesty, which are expensive to purchase, the use of the cars can be expanded dramatically. Further, if the present invention is applied to the sales of business cars, the purchase of which imposes additional fixed asset tax, purchasers of the cars such as companies can have an advantage of tax reduction.

Further, although the above description has been given with the car 20 being an example of the vehicle of the present invention, the vehicle of the present invention is not limited to the same. The vehicle is not limited to the car and may be any vehicle as long as it travels while carrying a person. Moreover, the place where the vehicle travels can be any place such as land, sea, sky, and the like. For example, the present invention can also be applied to the sales of motorcycles, boats, jet skis, helicopters, private aircraft, and the like and thus can contribute to the spread of these vehicles.

Further, although a case in which the order server 12A and the fee server 12B are separately provided has been described as an example, the present invention is not limited to the case. A server device having the functions of the order server 12A and the fee server 12B may be used.

1. (amended) A system for selling a vehicle, which has the function of transmitting data of a distance the vehicle has traveled, by information communication over a network, said system comprising:
an in-vehicle device which is mounted in the vehicle and comprises measuring means for measuring the travel distance of the vehicle and transmitting means for transmitting data of the measured travel distance; and
a control device comprising order receiving means for receiving a purchase order for the vehicle via the network, vehicle data receiving means for receiving the travel distance data, which has been transmitted from the in-vehicle device, at predetermined time intervals via the network after the vehicle for which the purchase order has been received is delivered to an orderer of the vehicle, calculating means for calculating a fee based on the received travel distance data, and charge signal outputting means which outputs a charge signal for charging the calculated fee to the orderer via the network.

2. The system of claim 1, wherein the control device further comprises order placement signal outputting means which outputs a signal for ordering the manufacture of the vehicle for which the purchase order has been received.

3. (amended) The system of claim 1 or 2, wherein the control device further comprises:
determination means for determining, based on the travel distance data received by the vehicle data receiving means, whether the vehicle has been used for a predetermined period; and
retrieval signal outputting means for outputting a signal for instructing retrieval of the vehicle when it has been determined by the determination means that the vehicle has not been used for the predetermined period.

4. The system of any one of claims 1 to 3, wherein:
the in-vehicle device further comprises position measuring means for measuring a position of the vehicle by a GPS;
the transmitting means transmits position data representing the measured position of the vehicle; and
the control device further comprises position data receiving means for receiving the position data, and checking means for checking the position of the vehicle based on the position data.

5. The system of claim 4, wherein:
the control device further comprises selecting means for selecting, from information on areas, information on an area around the position of the vehicle checked by the GPS, and area information delivering means for delivering the selected area information; and
the transmitting means receives the delivered area information.

6. The system of claim 5, wherein the area information is at least one of advertisement information and emergency information on the area.

7. The system of claim 6, wherein:
the in-vehicle device further comprises a monitor for displaying the received area information;
the transmitting means transmits a time period for which the received advertisement information has been displayed in the vehicle;
the control device further comprises advertisement fee charging means for receiving, when the area information is advertisement information, the transmitted time period for every advertisement information and charging an advertisement fee determined in accordance with the time period to an advertiser via the network; and
the calculating means subtracts an amount of money, which is determined based on the advertisement fee, from a fee calculated based on the travel distance data.

8. The system of any one of claims 1 to 7, wherein:
the in-vehicle device further comprises a status sensor for detecting status data representing at least one of engine speed, braking frequency, and steering wheel operation frequency of the vehicle;
the transmitting transmits the status data; and
the control device further comprises status data receiving means for receiving the status data via the network, and signal outputting means which outputs a signal for providing the status data to a manufacturer of the vehicle as data for research and development.

9. The system of any of claims 1 to 8, wherein the vehicle is a vehicle for nursing care or amnesty.

10. The system of any one of claims 1 to 8, wherein the vehicle is a business vehicle.

11. The system of any one of claims 1 to 10, wherein:
the in-vehicle device comprises a state sensor for detecting state data representing a state of the vehicle;
the transmitting means transmits the detected state data;
the vehicle data receiving means receives and stores the state data; and
the calculating means calculates a fee based on a price of the vehicle, which is obtained by subtracting a remaining value of the vehicle after a predetermined period from the price of the vehicle at the time of selling the vehicle, and the received travel distance data.

12. The system of claim 11, wherein the predetermined period is three years.

13. (amended) An area information delivering method which delivers information on an area via a network to a vehicle having the function of checking a current position thereof, the method comprising the steps of:
receiving position data representing the current position of the vehicle;
selecting, from information on areas, information on the area around the current position of the vehicle; and
delivering the selected area information to a receiving device provided at the vehicle.

14. (amended) The area information delivering method of claim 13, wherein the area information is at least one of advertisement information and emergency information on the area.

15. (amended) The area information delivering method of claim 14, further comprising the steps of:
receiving, when the area information is advertisement information, a time period for which the delivered advertisement information has been displayed in the vehicle from the vehicle for every advertisement information; and
charging an advertisement fee determined in accordance with the time period to an advertiser via the network.

16. (amended) A server device which performs information communication via a network, the server device comprising:
order receiving means for receiving a purchase order for a vehicle, which has the function of transmitting data of a distance the vehicle has traveled, via the network;
vehicle data receiving means for receiving the travel distance data at predetermined time intervals via the network after the vehicle for which the purchase order has been received is delivered to an orderer of the vehicle;
calculating means for calculating a fee based on the travel distance data received by the vehicle data receiving means; and
charge signal outputting means which outputs a charge signal for charging the fee calculated by the calculating means to the orderer via the network.

17. (amended) The server device of claim 16, further comprising order placement signal outputting means which outputs a signal for ordering the manufacture of the vehicle for which the purchase order has been received by the order receiving means.

18. (amended) The server device of claim 16 or 17, further comprising:
determination means for determining, based on the travel distance data received by the travel distance data receiving means, whether the vehicle has been used for a predetermined period; and
retrieval signal outputting means for outputting a signal for instructing retrieval of the vehicle when it has been determined by the determination means that the vehicle has not been used for the predetermined period.

19. (amended) The server device of any one of claims 16 to 18, further comprising:
position data receiving means for receiving data of a position of the vehicle measured by a GPS; and
checking means for checking the position of the vehicle based on the position data received by the position data receiving means.

20. (amended) The server device of claim 19, further comprising:
selecting means for selecting, from information on areas, information on an area around the position of the vehicle checked by the checking means; and
area information delivering means for delivering the area information selected by the selecting means to a receiving device provided at the vehicle.

21. (amended) The server device of claim 20, wherein the area information is at least one of advertisement information and emergency information on the area.

22. (amended) The server device of claim 21, further comprising advertisement fee charging means for receiving, when the area information is advertisement information, a transmitted time period, for which the delivered advertisement information has been displayed in the vehicle, for every advertisement information and charging an advertisement fee determined in accordance with the time period to an advertiser via the network;
wherein the calculating means subtracts an amount of money, which is determined based on the advertisement fee, from a fee calculated based on the travel distance data.

23. (amended) The server device of any one of claim 16 to 22, further comprising:
status data receiving means for receiving status data representing at least one of engine speed, braking frequency, and steering wheel operation frequency; and
signal outputting means which outputs a signal for providing the status data received by the status data receiving means to a manufacturer of the vehicle as data for research and development.

24. (amended) The server device of any one of claims 16 to 23, wherein:
the vehicle data receiving means receives and stores data representing a state of the vehicle; and
the calculating means calculates a fee based on a price of the vehicle, which is obtained by subtracting a remaining value of the vehicle after a predetermined period from the price of the vehicle at the time of selling the vehicle, and the travel distance data received by the vehicle data receiving means.

25. (amended) The server device of claim 24, wherein the predetermined period is three years.

26. (added) A server device which delivers information on an area via a network to a vehicle having the function of checking a current position thereof, said server device comprising:
position receiving means for receiving position data representing the current position of the vehicle;
selecting means for selecting, from information on areas, information on an area around the current position of the vehicle; and
area information delivering means for delivering the area information selected by the selecting means to a receiving device provided at the vehicle.

27. (added) The server device of claim 26, wherein the area information is at least one of advertisement information and emergency information on the area.

28. (added) The server device of claim 27, further comprising advertisement fee charging means for receiving, when the area information is advertisement information, a transmitted time period, for which the delivered advertisement information has been displayed in the vehicle, for every advertisement information and charging an advertisement fee determined in accordance with the time period to an advertiser via the network.

29. (added) An area information displaying and charging system for a vehicle, comprising:
an in-vehicle device which is mounted in the vehicle and comprises transmitting means for detecting a distance the vehicle has traveled and a current position of the vehicle and transmitting distance information and positional information, and display means for displaying received area information; and
a control device which comprises area information transmitting means that stores information on predetermined areas and transmits area information corresponding to the positional information, and fee processing means for processing a fee in accordance with the travel distance.
